(19) United States
(12) Patent Application Publication
(10) Pub. No.: US 2025/0168074 A1
(43) Pub. Date: May 22, 2025

(54) METHOD AND APPARATUS FOR NETWORK SLICING

(71) Applicant: Nokia Technologies Oy, Espoo (FI)

(72) Inventors: Halit Murat GÜRSU, Munich (DE); Philippe GODIN, Massy (FR); György Tamás WOLFNER, Budapest (HU); Muhammad NASEER-UL-ISLAM, Munich (DE); Ömer BULAKCI, Munich (DE); Alessio CASATI, West Molesey (GB)

(21) Appl. No.: 18/724,908

(22) PCT Filed: Jan. 5, 2022
(86) PCT No.: PCT/FI2022/050012

§ 371 Date: Jun. 27, 2024

(51) Int. Cl. H04L 41/0895; H04W 36/00; H04W 74/0833

(52) U.S. Cl. CPC H04L 41/0895; H04W 36/13; H04W 74/0833

(57) ABSTRACT

The disclosure inter alia relates to a user device for slice management, comprising at least one processor, wherein the at least one processor is configured to: obtain a slice group mapping (SGM) configuration, wherein the SGM configuration indicates a mapping between a slice group and a tracking area (TA); and perform cell reselection and/or random access operation, at least partially based on the obtained SGM configuration.

### TECHNICAL FIELD

Various example embodiments according to the present disclosure relate to network slicing of communication networks. Specifically, various example embodiments according to the present disclosure relate to slice group mapping configuration.

### BACKGROUND

Network slicing is a key 5G feature to support different services using the same underlying mobile network infrastructure. For example, a network slice may be understood as a logical network that provides specific network capabilities and network characteristics in order to serve a defined business purpose of a customer. In order to benefit from such slice-specific network services, a user device may require information in form of slice groups for performing slice-specific network cell selection and/or random access operation e.g. to a particular network cell.

However, supporting slice group in the radio access network (RAN) was initiated by 3GPP (3rd Generation Partnership Project) recently. In order to support slice group in the 5G system, many problems and challenges need to be solved.

### SUMMARY

Certain embodiments may allow determining a slice group mapping (SGM) configuration and providing this SGM configuration to a user device for performing cell reselection and/or random access operation.

According to a first exemplary aspect, a user device is disclosed, comprising at least one processor, wherein the at least one processor is configured to:
obtain, by the user device a slice group mapping, SGM, configuration, wherein the SGM configuration indicates a mapping between a slice group and tracking area, TA; and
perform cell reselection and/or random access operation, at least partially based on the obtained slice group mapping configuration.

Further according to a first exemplary aspect, a user device is disclosed, comprising at least one processor and at least one memory including computer program code, the at least one memory and the computer program code configured to, with the at least one processor, cause the user device at least to perform:
obtain a slice group mapping (SGM) configuration, wherein the SGM configuration indicates a mapping between a slice group and a tracking area (TA); and
perform cell reselection and/or random access operation, at least partially based on the obtained SGM configuration.

According to a second exemplary aspect, a first network node is disclosed, comprising at least one processor, wherein the at least one processor is configured to:
obtain, by the first network node, a slice group mapping, SGM, configuration, wherein the SGM configuration indicates a mapping between a slice group and tracking area, TA;
provide the SGM configuration to a user device.

Further according to a second exemplary aspect a first network node is disclosed, comprising at least one processor and at least one memory including computer program code, the at least one memory and the computer program code configured to, with the at least one processor, cause the network node at least to perform:
obtain an SGM configuration, wherein the SGM configuration indicates a mapping between a slice group and a tracking area; and
provide the SGM configuration to a user device.

According to the first exemplary aspect, a method is disclosed, wherein the method comprises:
obtain, by a user device, an SGM configuration, wherein the SGM configuration indicates a mapping between a slice group and a tracking area; and
perform, by the user device, cell reselection and/or random access operation, at least partially based on the obtained SGM configuration.

According to the second exemplary aspect, a method is disclosed, wherein the method comprises:
obtain, by a first network node, an SGM configuration, wherein the SGM configuration indicates a mapping between a slice group and a tracking area; and
provide, by the first network node, the SGM configuration to a user device.

In some examples, the methods and/or apparatuses according to the first and/or second exemplary aspects (e.g. the user device and the first network node) may be understood as methods and apparatuses for slice management. Accordingly, according to the first exemplary aspect, a user device for slice management (e.g. for obtaining and/or for provisioning slice group mapping) and a method for slice management (e.g. for obtaining and/or for provisioning slice group mapping) are disclosed, and according to the second exemplary aspect, a first network node for slice management (e.g. for obtaining and/or for provisioning slice group mapping) and a method for slice management (e.g. for obtaining and/or for provisioning slice group mapping) are disclosed.

In some examples, the method according to the first exemplary aspect and/or the method according to the second exemplary aspect may be understood as a method for provisioning of slice group mapping (e.g. slice group mapping information in a first registration area which may e.g. be assigned to the user device to which the SGM configuration is provided by the first network node).

According to a third exemplary aspect, a system is disclosed, wherein the system at least comprises a user device according to the first exemplary aspect and a first network node according to the second exemplary.

The disclosed user device may be understood as a user equipment (UE). The user device may be stationary device or a mobile device. The user device may in particular be a mobile device, such as a smartphone, a tablet, a wearable, a smartwatch, a low power device, an IoT (Internet-of-Things) device, an IIoT (Industrial IoT) device or the like. The user device may in particular be capable of obtaining sensor data (e.g. from an external device) and transmit the received sensor data to the network node of a communication network. Generally, the user device may also be any other device enabled for communication with a respective communication network, such as a vehicle, for instance a car or a truck. A user device or mobile station may be understood as any device used to communicate with a respective network. The user device of the first exemplary aspect may be capable of being in direct or indirect communication with a network node of a communication network as will be explained in more detailed below.

A first network node may be understood to be a network node of a radio access network (RAN) or a network node of a core network (CN).

A respective network node of a core network (also referred to as core network node) may be understood as an entity or function of a communication network of any generation. Generally, the core network node may be or comprise a hardware or software component implementing a certain functionality. Accordingly, while the core network node may be understood to be implemented in or be a single device or module, the core network node may also be implemented across or comprise multiple devices or modules. In particular, a core network node may be understood as network function and/or network entity as defined by the 3GPP 5G or NR (new radio) standard (see e.g. 3GPP TS 23.501 version 16.10.0, sections 3 and 4).

Accordingly, the 5G system architecture may comprise an access and mobility management function (AMF), a session management function (SMF) and further functions or entities. In particular, the core network node may be implemented in an AMF, which may for example handle control signaling between the core network and user devices, security for user data, idle-state mobility, and authentication. The functionality operating between the core network, more specifically the AMF, and the user devices may be referred to as the non-access stratum (NAS), to separate it from the access stratum (AS), which handles functionality operating between user devices and the radio access network.

A respective network node of a RAN (also referred to as radio access network node) may be understood as a wireless communication station installed at a fixed or mobile location and may for example be a communication network of any generation (e.g. a gNB, eNodeB, NodeB, BTS or the like) of the 3GPP standard. Generally, a radio access network node may be or comprise a hardware or software component implementing a certain functionality. In an example, a radio access network node may be base station as defined by the 3GPP 5G or NR standard (also referred to as gNB). Accordingly, while a radio access network node may be understood to be implemented in or be a single device or module, a radio access network node may also be implemented across or comprise multiple devices or modules. As such, a radio access network node may in particular be implemented in or be a stationary device. Multiple radio access network nodes may in particular establish a communication system or radio access network, which may in particular be a New Radio (NR) or 5G system (5GS) or any other mobile communications system defined by a past or future standard, in particular successors of the present 3GPP standards. A radio access network node may be capable of being in direct and/or indirect communication with one or more user devices as for example disclosed according to the first exemplary aspect or with one or more further radio access network nodes, as will be explained in more detail below.

Referring to one or more radio access network nodes and one or more core network nodes, these nodes may be capable of being in direct and/or indirect communication with each other. According to the 5G architecture, a gNB may be connected to the 5G core network by means of the NG interface, while the Xn interface may connect several gNBs to each other.

In general, the means of any of the disclosed apparatuses according to the first and/or second exemplary aspect (i.e. the user device and first network node) can be implemented in hardware and/or software. They may comprise one or multiple modules or units providing the respective functionality. They may for instance comprise at least one processor (e.g. for executing computer program code for performing the required functions), at least one memory storing the program code, or both. Therein, it shall be considered as disclosed that a respective apparatus (i.e. the user device and/or first network node) may comprise at least one processor alone (e.g. without any further memory or program code stored therein) that is configured to perform method steps as disclosed according to the various aspects. Alternatively, they could comprise for instance circuitry that is designed to implement the required functions, for instance implemented in a chipset or a chip, like an integrated circuit. In general, the means may comprise for instance one or more processing means or processors.

Thus, according to the first and/or second exemplary aspect of the present disclosure, there is disclosed a respective apparatus (i.e. the user device and network node) comprising at least one processor and at least one memory including computer program code, the at least one memory and the computer program code configured to, with the at least one processor, cause an apparatus at least to perform a method according to the respective aspects of the present disclosure. Likewise, according to the respective exemplary aspects of the present disclosure, there is in each case disclosed a respective apparatus (i.e. the user device and network node) comprising means for performing a method according to the first and/or second exemplary aspect.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the first and/or second exemplary aspect, there is also disclosed a computer program, the computer program when executed by a processor of an apparatus (e.g. the user device and network node) causing said apparatus to perform a method according to the first and/or second exemplary aspect.

The computer program may in each case be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

Obtaining an SGM configuration by a user device may for example be understood to mean that the SGM configuration may be received by the user device from a network (e.g. a radio access network or a core network, e.g. according to the second exemplary aspect) and more particular from another entity such as a network node, which may for example be a network node of a radio access network (i.e. a radio access network node) as described above or a network node of a core network (i.e. a core network node) as described above. For example, the SGM configuration may be received by the user device via broadcast signaling or in dedicated signaling as it will be further discussed below.

An SGM configuration (e.g. as configured by a network) is indicative of at least one mapping between a slice group and a tracking area, which may for example be understood to mean that the SGM configuration comprises an information which is associated with at least one mapping between a slice group and a tracking area (e.g. by referring or by pointing to the least one mapping). The SGM configuration may not explicitly comprise the at least one mapping. In another example, indicating the at least mapping between a slice group and a tracking area may be understood to mean that the SGM configuration comprises the at least one mapping. For example, an SGM configuration indicating or comprising the least one mapping between a respective slice group and a tracking area means that the SGM configuration indicates or comprises at least information on the at least one slice group, further information on the corresponding tracking area and/or for example any further indication or information on the slice group and tracking area being mapped to each other.

For example, a SGM configuration indicating (or e.g. comprising) at least one mapping between a slice group and a tracking area may be understood as the SGM configuration indicating (or e.g. comprising) one or more or for example a plurality of mappings between a respective slice group and a respective tracking area. In other words, referring to for example a pair of a respective slice group and a tracking area to which the slice group is mapped, the SGM configuration may indicate (or e.g. comprise) at least one such pair, or one or more, or a plurality of such respective pairs of a slice group and a tracking area.

A slice group may for example be understood as information that is necessary for a user device to perform slice specific cell reselection and/or slice specific random access operation, for example with respect to or to a network cell to which the user device is intended to connect. In other words, slice specific cell reselection or slice specific random access channel information may be provided in the form of slice groups to the user device. According to some examples, a respective slice group may comprise at least one slice to slice group mapping as further described below.

For example, in order to be used by a user device for performing slice specific cell reselection to a respective network cell (and/or slice specific random access channel operation to a radio access network node providing the respective network cell), the respective slice group needs to be specific to the respective network cell (which e.g. may be provided by a respective radio access network node). This may also be understood to mean that the respective slice group is valid for the respective network cell to which the respective slice group is specific.

Additionally or alternatively, the respective slice group needs to be specific to a respective tracking area that includes the respective network cell. Accordingly, a slice group may be specific to a respective network cell and additionally or alternatively specific to a tracking area including a respective network cell.

It shall be understood that a tracking area refers to a group of network cells which are for example provided by a particular radio access network node. In other cases, a group of network cells may also be grouped to a particular radio access network area identified by a radio access network area identifier (RAI), wherein a plurality of radio access network areas are grouped together into a tracking area. Such a tracking area including a plurality of network cells (which are, e.g. grouped to respective radio access network areas) may be typically identified by a tracking area identifier (TAI). Tracking areas may be understood as basis for tracking a user device. To that purpose, a user device may be assigned to a respective registration area (e.g. by the core network) consisting or comprising of a list of tracking area identifiers. For example, when a user device enters a network cell that belongs to a tracking area not included in a registration area assigned to the user device, the user device may access the core network and perform a non-access stratum (NAS) registration update. Accordingly, the core network may register the user device location and update the device registration area, for example by providing the user device with a new tracking area identifier list that includes a new tracking identifier.

For example, as used herein, a network slice may be understood as a logical network that provides specific network capabilities and network characteristics in order to serve a defined business purpose of a customer. For example, network slicing allows multiple virtual networks to be created on top of a common shared physical infrastructure. A network slice may consist of or comprise different subnets, such as for example a radio access network subnet, a core network subnet and/or a transport network subnet. Typically, a telecommunication service provider may be the owner or tenant of the network infrastructures from which network slices may be created.

As for example further described in the 3GPP technical specifications, a network slice is uniquely identified via the S-NSSAI (single-network slice selection assistance information). A user device may be simultaneously connected and served by at most eight network slices associated with eight S-NSSAIs. On the other hand, a respective network cell may support tens or even hundreds of S-NSSAIs. For example, when a user device registers to a network, it may indicate one or more or the slices to which it might need access (e.g. via requested S-NSSAIs). Further to this example, the core network may analyze a user device profile and subscription data to verify such a list of slices the user device may be allowed to have access to. As a result, the core network may send a list of allowed slices to the user device (e.g. allowed NSSAI). The list of allowed slices could be different or only a subset of the requested slices from the user device in the registration process. The reason may be that the user device may not have access to a specific slice or the slice is not supported in the current location in which the registration request was initiated.

Regarding a particular tracking area, one or more of same network slices may be supported within one tracking area, which may be referred to as uniform or homogeneous slice support. For example, whenever a user device may for example move and is thus supposed to perform slice specific cell reselection or slice specific random access channel (e.g. to a new network cell or to a new radio access network node providing the new network cell), the user device may require corresponding information on such slice groups specific to a new network cell. Assuming that for example the new network cell belongs to the same tracking area as the network cell the user device was previously connected to, the user device may use the slice group already available at the user device for connecting to the reselected new network cell, given that the tracking area to which the new network cell and the previously connected network cell belong provides homogeneous slice support.

Performing cell reselection and/or random access operation (e.g. slice specific cell reselection and/or slice specific random access operation) e.g. to a network cell at least partially based on the obtained SGM configuration may for example be understood to mean that performing cell reselection and/or random access operation may be based on the at least one mapping between a slice group and a tracking area indicated by (e.g. by being contained in) the SGM configuration. For example, performing cell reselection and/or random access operation may be at least partially based on the respective mapping of a respective slice group to the respective tracking area including the respective network cell. In particular, such a mapping may enable the user device to use a particular slice group which is specific to a respective tracking area including a respective network cell to which the cell reselection and/or random access operation is to be performed. For example, performing reselection and/or random access operation may comprise steps such as selecting particular random access channel resources and/or making correct frequency prioritization.

Advantageously, the user device may thus be able to perform slice specific cell reselection and/or random access operation e.g. to a network cell based on corresponding information contained or comprised in a slice group specific to the respective network cell. The user device may benefit from network slice based services when connecting to a network cell e.g. by means of at least one mapping between the required slice group and a tracking area which includes the respective network cell.

In other examples as further described below, it may occur that the user device is intended to perform cell reselection and/or random access operation e.g. to a network cell which is included in a respective tracking area for which no corresponding slice group mapping is indicated (e.g. comprised) in the obtained SGM configuration. For example, after determining (e.g. by the user device) that such a case is present based on the obtained SGM configuration, the user device may proceed with a fall back option as further described below.

Referring to a first network node, before providing an SGM configuration indicating at least one mapping between a slice group and a tracking area to a user device, the SGM configuration is obtained by the network node. In some examples, obtaining the SGM configuration may be understood to mean that the network node may obtain the SGM configuration by determining the SGM configuration, while in further examples, the network node may obtain the SGM configuration by obtaining it from a memory of the network node. In other examples, the step of obtaining may be understood as receiving the SGM configuration from another network node (e.g. a radio access network node or a core network node) as further discussed below.

In some examples, determining an SGM configuration may comprise selecting one or more mappings between a respective slice group and a respective tracking area from a plurality of such mappings. Therein, the selected one or more mappings may be mappings between a respective slice group and a respective tracking area, wherein the respective tracking area is neighboring a tracking area that belongs to at least one of a registration area assigned to a user device (e.g. a user device to which the SGM configuration is provided) and a radio access network notification area assigned to a user device (e.g. a user device to which the SGM configuration is provided).

Providing the SGM configuration may for example be understood to mean that the SGM configuration is provided to a user device (e.g. a user device according to the first exemplary aspect) by transmitting the configuration by the network node to the user device. Subsequently, the SGM configuration may be available at the user device as a basis for performing cell reselection and/or random access operation as described above. The first network node according to the second exemplary aspect may thus provide a respective SGM configuration for example to a user device and by this way enable the user device to perform slice specific cell reselection and/or random access operation based on corresponding information contained in a slice group specific to a respective network cell.

In the following, further exemplary features and exemplary embodiments of the different aspects of the present disclosure will be described in more detail.

According to an exemplary embodiment of the first exemplary aspect, the SGM configuration is obtained (by the user device according to the first exemplary aspect) from at least one of a core network and a radio access network (e.g. according to the second exemplary aspect).

According to another exemplary embodiment of the first exemplary aspect, obtaining the SGM configuration from a core network comprises:
obtaining the SGM configuration in non-access stratum; and
wherein obtaining the SGM configuration from a radio access network comprises:
obtaining the SGM configuration in a downlink signaling and/or message.

Further according to an exemplary embodiment of the first exemplary aspect, the obtain, by the user device, a SGM configuration comprises:
obtain the SGM configuration from core network; or
obtain the SGM configuration from radio access network.

Further according to an exemplary embodiment of the first exemplary aspect, the obtain the SGM configuration from core network comprises:
obtain the SGM configuration in non-access stratum (NAS) signaling and/or message; and
wherein the obtain the SGM configuration from radio access network comprises:
obtain the SGM configuration in a radio resource control (RRC) signaling and/or message.

Considering an example, the SGM configuration may be obtained by the user device from a network, wherein the network may be a core network or a radio access network. In particular, the network may be represented by a network node of the second exemplary aspect. With respect to the 5G architecture, further details on the overall structural and functionality of the core network and radio access network may be found in according technical specifications (see e.g. 3GPP TS 23.003). When obtaining an SGM configuration from a core network, the SGM configuration may more specifically be obtained from a core network node such as for example the AMF via the non-access stratum. In other examples, when obtaining an SGM configuration from a radio access network, the SGM configuration may more specifically obtained from a radio access network node such as for example a base station as defined by the 3GPP 5G or NR standard (also referred to as gNB). In this example, the SGM configuration may be obtained by the user device in a downlink signaling (e.g. a RRCReconfiguration) and/or message (e.g. a handover message).

According to an exemplary embodiment of the first exemplary aspect, the at least one memory and the computer program code are further configured to, with the at least one processor, cause the user device to further perform:
checking whether the SGM configuration is valid for a second TA when the user device moves from a first TA to the second TA; and/or
checking whether the SGM configuration is valid for a second registration area (RA) when the user device moves from a first RA to the second RA.

Further according to an exemplary embodiment of the first exemplary aspect, the at least one processor is further configured to:
check whether the SGM configuration is valid for a second TA when the user device moves from a first TA to the second TA; or
check whether the SGM configuration is valid for a second registration area, RA, when the user device moves from a first RA to a second RA.

In an example, the user device may move (e.g. an idle/inactive mode) within one particular tracking area or from one tracking area (e.g. a first tracking area to which e.g. the user device was previously connected) to another tracking area (e.g. a second tracking area which the user device may have selected by cell reselection, e.g. by selecting a network cell belonging to the second tracking area). In such an example, the user device may be supposed to perform cell reselection and/or random access operation e.g. to a network cell belonging to the second tracking area, for which a corresponding slice group (e.g. a slice group which is specific to the respective network cell included in the second tracking area) may be required. In such an example, the user device may check whether the obtained SGM configuration is valid for the second tracking area. In particular, this may be understood to mean that it is checked at or by the user device whether the second tracking area may correspond to a particular tracking area for which the obtained SGM configuration indicates at least one mapping (e.g. a mapping between a slice group and the particular tracking area). Accordingly, the obtained SGM configuration may for example be considered valid for the second tracking area if the at least one mapping between a slice group and a tracking area indicated by the SGM configuration is a mapping between a slice group and the second tracking area. In the case that the obtained SGM configuration is valid for the second tracking area, the user device may perform cell reselection and/or random access operation e.g. to a respective network cell belonging to the second tracking area for example at least partially based on the obtained SGM configuration (which e.g. indicates or comprises a mapping between a slice group and the second tracking area).

In some examples of all exemplary aspects, the first tracking area may be a neighboring tracking area of the first tracking area, which may be understood as for example the coverage of a network cell belonging to the first tracking being located adjacent to the coverage of a network cell belonging to the second tracking area. In further examples of all exemplary aspects, the first tracking area may be a non-neighboring tracking area of the second tracking area.

In another example of all exemplary aspects, the first tracking area may belong to the same registration area (e.g. a first registration area, which is for example assigned to the user device) as the second tracking area. In this example, the respective tracking area identifiers of the first and second tracking area may both be listed in the same registration area. In such a case, the obtained SGM configuration may be valid for the second tracking area in particular if for example the SGM configuration has been determined (e.g. by a network node from which the user device obtains the SGM configuration) at least partially based on the registration area to which the first and second tracking areas belong e.g. as further described below.

In another example of all exemplary aspects, the user device may move from a first registration area to a second registration area which is different from the first registration area, such that the user device may be supposed to perform cell reselection and/or random access operation e.g. to a network cell belonging to a tracking area that is listed in the second registration area and not in the first registration area. Accordingly, the user device may check whether the obtained SGM configuration is valid for the second registration area. In particular, this may be understood to mean that it is checked at the user device whether any tracking area listed in the second registration area may correspond to a particular tracking area for which the obtained SGM configuration indicates at least one mapping (e.g. a mapping between a slice group and the particular tracking area). Accordingly, the obtained SGM configuration may for example be considered valid for the registration tracking area if the at least one mapping between a slice group and a tracking area indicated by the SGM configuration is a mapping between a slice group and a tracking area belonging to the second registration area.

Considering the examples of all exemplary aspects above, if, the respective checking yields in the result that the SGM configuration is valid for the second tracking area and/or for the second registration, the user device may proceed with performing cell reselection and/or random access operation e.g. to a corresponding network cell, at least partially based on the obtained SGM configuration.

According to an exemplary embodiment of the first exemplary aspect, the at least one memory and the computer program code are further configured to, with the at least one processor, cause the user device to further perform:
fall back to a legacy random access channel (RACH), wherein the legacy RACH comprises using RACH resources without SGM support.

Further according to an exemplary embodiment of the first exemplary aspect, the at least one processor is further configured to:
fall back to a legacy random access channel, RACH, wherein the legacy RACH comprises using RACH resources without SGM support.

As disclosed above, in some examples the user device may be intended to perform cell reselection and/or random access operation e.g. to a network cell which is included in or comprised by a respective tracking area for which no corresponding slice group mapping is indicated in the obtained SGM configuration. In such cases, the user device may fall back to a legacy random access channel, wherein the legacy random access channel may be a random access channel without SGM support. In another example, the legacy random access channel may use random access channel resources that are not mapped to any slice group. This may allow that potential failure operation due to slice specific reselection or slice specific random access operation without having a valid SGM configuration available at the user device may be avoided by falling back to a legacy mechanism respectively operation.

According to an exemplary embodiment of the first exemplary aspect, the at least one memory and the computer program code are further configured to, with the at least one processor, cause the user device to further perform:
indicate an invalid SGM configuration to a network in an uplink signaling and/or message, wherein the uplink signaling and/or message comprises a message 3 (MSG3), a message 5 (MSG5) or a message 1 (MSG1) of a RACH procedure or a radio resource control (RRC) signaling.

Further according to an exemplary embodiment of the first exemplary aspect, the at least one processor is further configured to:
indicate invalid SGM to a network in an uplink signaling and/or message, wherein the uplink signaling and/or message comprises message 3, MSG3 or MSG5 or MSG1 of a random access channel, RACH or RRC signaling.

As disclosed above, an invalid SGM configuration may for example be present if a particular SGM configuration does not indicate a mapping between a slice group and a particular tracking area which includes or comprises a network cell to which for example the user device is intended to perform cell reselection and/or random access operation. In such a case, the user device may indicate to a network (e.g. a radio access network node or a core network node, e.g. according to the second exemplary aspect) that the obtained SGM configuration is invalid. For such indication, a message 3 as for example known from a four step random access procedure between a user device and a network (comprising a preamble, a response, a message 3 and a message 4) may be used, for example in order to report an invalid SGM configuration to a respective network. In further examples of all exemplary aspects, any other uplink message (e.g. for an idle/inactive user device) may be used to indicate an invalid SGM configuration. In response to indicating an invalid SGM configuration, the respective network may for example provide another (e.g. a valid) SGM configuration (e.g. an SGM reconfiguration), for example by using a downlink message (e.g. a message 5) or a RRCreconfiguration message.

According to an exemplary embodiment of the first exemplary aspect or second aspect, the SGM configuration comprises at least one of:
a set of slice groups mapping to a set of TAs;
one or more mappings between a slice group and a TA; and
one or more mappings between a physical cell identifier (PCI) and a slice group.

According to another exemplary embodiment of the first exemplary aspect and/or second exemplary aspect, the slice group mapping further comprises at least one slice to slice group mapping.

To name but one non-limiting example, it may be assumed that a particular SGM configuration indicates (e.g. by comprising) three mappings between a respective slice group (e.g. slice group 1, slice group 2, slice group 3) and a respective tracking area (tracking area 1, tracking area 2, tracking area 3), wherein slice group 1 may be specific to tracking area 1, slice group 2 may be specific to tracking area 2 and slice group 3 may be specific to tracking area 3. In this case, the set of slice groups of slice groups 1 to 3 may be understand as corresponding to (e.g. and thus being mapped to) the set of tracking areas 1 to 3. Accordingly, the SGM configuration may comprise one or more mappings (in the present example three mappings) between the respective slice group and the corresponding tracking area (i.e. in the present example, one mapping between slice group 1 and tracking area 1, one further mapping between slice group 2 and tracking area 2 and one further mapping between slice group 3 and tracking area 3). Considering that the tracking areas 1, 2 and 3 include or comprise different network cells, the three mappings indicated in the SGM configuration may for example be one mapping between a respective network cell belonging to tracking area 1 and slice group 1, one mapping between a network cell belonging to tracking area 2 and slice group 2 and a mapping between a network cell belonging to tracking area 3 and slice group 3. Therein, a respective network cell may for example be represented by a corresponding physical cell identifier According to further examples of all exemplary aspect, a respective slice group mapping may comprise at least one slice to slice group mapping. For example, a slice group may indicate a list of slices, wherein the indication of a list of slices by each slice group may be understood as a slice to slice group mapping. For example, slice group 1 maps to slice 1 and slice 2 and slice group 2 maps to slice 3 and slice 5. Therein, if a particular slice group is for example specific and thus mapped to a respective tracking area, the respective slice to slice group mapping contained in or comprised by the slice group may likewise be considered as specific and thus be mapped to the respective tracking area.

The SGM configuration that indicates at least one mapping between a slice group and a tracking area and that is provided to the user device may be obtained at the user device and used when performing cell reselection and/or random access operation to a network cell. In some examples, further conditions on how the SGM configuration is provided to a user device may depend on whether the SGM configuration is provided by for example a radio access network node or a core network node e.g. as further disclosed below.

According to an exemplary embodiment of the second exemplary aspect, the at least one memory and the computer program code are further configured to, with the at least one processor, cause the first network node to further perform:
determine the SGM configuration.

Further according to an exemplary embodiment of the second exemplary aspect, the at least one processor is further configured to:
determine the SGM configuration.

According to another exemplary embodiment of the second exemplary aspect, the at least one memory and the computer program code are further configured to, with the at least one processor, cause the first network node to further perform:
determine the SGM configuration based on at least one mapping between a slice group and a TA and in particular further based on a registration area assigned to the user device.

According to yet another exemplary embodiment of the second exemplary aspect, the at least one memory and the computer program code are further configured to, with the at least one processor, cause the first network node to further perform:
obtain a registration area RA configuration of the user device from a core network node to determine the SGM configuration.

Further according to an exemplary embodiment of the second exemplary aspect, the at least one processor is further configured to:
obtain a registration area, RA, configuration of the user device from a core network node to determine the SGM configuration.

As described above regarding the obtaining an SGM configuration, the network node may perform a step of determining the SGM configuration. For example, determining the SGM configuration may at least partially be based on at least one mapping (e.g. which has been obtained at the network node) and it may further be based on other information. According to the exemplary embodiment mentioned above, determining the SGM configuration may be based on at least one mapping between a slice group and a tracking area and may be further based on a registration area assigned to the user device. This may be understood to mean that, for example, the network node obtains a plurality of mappings between respective slice groups and tracking areas and selects particular mappings from this plurality of mappings which may map one or more slice groups to one or more tracking areas included in or comprised by a registration area (e.g. a registration area assigned to the user device to which the SGM configuration is to be provided). In other words, the obtained at least one mapping between a slice group and a tracking area may be matched with the one or more tracking areas included in or comprised by a registration area.

For example, the network node may obtain one or more mappings between a respective slice group and a tracking area (e.g. slice group 1 mapped to tracking area 1, slice group 2 mapped to tracking area 2, slice group 3 mapped to tracking area 3). Additionally, the network node may obtain a registration area which lists tracking areas 1 and 2. The network node may then determine the SGM configuration by selecting the mapping between slice group 1 and tracking area 1 and slice group 2 and tracking area 2, since these mappings relate to the respective tracking areas included in or comprised by the registration area.

Determining an SGM configuration at least partially based on the registration area assigned to a user device (e.g. the user device to which the SGM configuration is provided) may allow to ensure that the SGM configuration indicates (e.g. comprises) mappings between slice groups and tracking areas for all tracking areas included in the registration area assigned to a user device (e.g. the user device to which the SGM configuration is provided).

Further regarding the exemplary embodiment mentioned above, it is to be noted that using a registration area, when determining a respective SGM configuration, does not depend on whether the network node at which the SGM configuration is determined is a radio access network node or a core network node. Considering examples of the network node of the second exemplary aspect being a core network node, a registration area (e.g. the registration area assigned to the user device to which the SGM configuration is provided) may be available at the core network node. In other examples of the network node being a radio access network node of the second exemplary aspect, no registration area may be initially available at the radio access network node (e.g. since the radio access network node is generally unaware of registration areas assigned to user devices). In such examples, the radio access network node may obtain one or more registration areas (e.g. a registration area assigned to the user device to which the SGM configuration is provided) and then use these one or more registration areas when determining an SGM configuration. For example, the radio access network node may obtain one or more registration areas from a core network, in particular from a core network node such as an AMF (e.g. via the NG interface).

In some examples of the second exemplary aspect, assuming that the network node is a radio access network node which obtains one or more registration areas from a core network, such obtaining may be performed and/or controlled in response to an initial message sent by the radio access network node to the core network. For example, this initial message may include or comprise information specific to a user device (e.g. according to the first exemplary aspect) to which a respective SGM configuration is to be provided, for example by establishing a connection (e.g. by means of RRC connection establishment) between the radio access network node and the particular user device before sending the initial message to the core network. In such examples, the core network may respond to the initial message sent by the radio access network node by providing an initial context setup including a registration area assigned to the user device for which the initial message includes specific information.

As described above, obtaining the registration area assigned to the user device may be understood to mean that the registration area may be available at the network node and thus may be obtained for example from a memory of the network node. In other examples, the registration area may be obtained (e.g. received) at the network node from one or more network nodes (e.g. from a core network node such as an AMF).

According to another exemplary embodiment of the second exemplary aspect, the at least one memory and the computer program code are further configured to, with the at least one processor, cause the first network node to further perform:
obtain an assistant information, wherein the assistant information indicates the user device having invalid SGM configuration; and/or
provide a valid SGM configuration to the user device based on the indicated invalid SGM configuration.

Further according to an exemplary embodiment of the second exemplary aspect, the at least one processor is further configured to:
obtain an assistant information, wherein the assistant information indicates the user device having invalid SGM configuration; and/or
provide a valid SGM configuration to the user device based on the indicated invalid SGM configuration.

For example, the assistant information may be obtained from the user device at which the invalid SGM configuration is present. In such a case, the invalid SGM configuration may be present at the user device after obtaining (e.g. receiving) the SGM configuration at the user device (e.g. from the network node).

According to another exemplary embodiment of the second exemplary aspect, the first network node further comprises at least one transceiver, wherein the at least one transceiver is configured to:
transmitting a slice configuration update to a second network node, wherein the slice configuration update comprises at least one SGM configuration; or
receiving a slice configuration update from a second network node, wherein the slice configuration update comprises at least one SGM configuration.

For example, the second network node may be a radio access network node or a core network node (e.g. an AMF). For example, the slice configuration update may be transmitted to the second network node in a radio access network configuration update (RAN configuration update), wherein the second network node may receive a plurality of radio access network configuration updates from a plurality of respective network nodes. In such an example, the second network node may be a core network node (e.g. an AMF) that collects a plurality of SGM configurations from various radio access network nodes.

In other examples, the first network node may receive a slice configuration update from the second network node in a radio access network configuration update (RAN configuration update). The first network node may then provide the SGM configuration contained in the radio access network configuration update to the user device.

According to an exemplary embodiment of the second exemplary aspect, the first network node comprises a core network node or a radio access network node.

For example, whether the network node may be a core network node or a radio access network node may affect the way of providing the SGM configuration to a user device and the way of obtaining at least one mapping between a slice group and a tracking area as it is further disclosed in the following.

According to another exemplary embodiment of the second exemplary aspect, the network node is a core network node and the SGM configuration is provided to the user device in non-access stratum; or wherein the network node is a radio access network node and wherein the SGM configuration is provided to the user device in a downlink signaling and/or message.

Considering an example, the SGM configuration may be provided by a core network node or a radio access network node to a respective user device. With respect to the 5G architecture as an example, when providing a respective SGM configuration by a core network node, the SGM configuration may more specifically be provided by a core network node such as for example the AMF via the non-access stratum. In other examples, when providing a respective SGM configuration by such a radio access network node, the SGM configuration may more specifically be provided by a radio access network node such as for example a base station as defined by the 3GPP 5G or NR standard (also referred to as gNB). In this example, the SGM configuration may be obtained by the user device in a downlink signaling (e.g. a RRCreconfiguration) and/or message (e.g. a handover message).

According to an exemplary embodiment of the second exemplary aspect, the network node is a core network node and at least one mapping between a slice group and a tracking area and/or at least one SGM configuration is obtained from one or more further radio access network nodes.

According to another exemplary embodiment of the second exemplary aspect, the network node is a core network node and at least one mapping between a slice group and a tracking area and/or at least one SGM configuration is obtained from one or more further radio access network nodes in one or more radio access network configuration updates.

Considering an example of the network node being a core network node, it may be the case that the core network node obtains at least one mapping between a slice group and a tracking area and/or at least one SGM configuration from one or more radio access network nodes (e.g. in one or more respective radio access network configuration updates). For example, the core network node may obtain a plurality of mappings between a respective slice group and a respective tracking area from a plurality of radio access network nodes, wherein a respective mapping of the plurality of mappings may be obtained from a respective radio access network node (e.g. in a respective radio access network configuration update). In particular, a respective mapping between a slice group and a tracking area may be obtained from a radio access network node that provides a respective network cell included in or comprised by the respective tracking area.

According to an exemplary embodiment of the second exemplary aspect, the first network node is a radio access network node and:
the at least one mapping between a slice group and a tracking area and/or at least one SGM configuration is obtained from a core network node; or
the at least one mapping between a slice group and a tracking area and/or at least one SGM configuration is obtained from one or more further radio access network nodes.

In some examples, the network node may be a radio access network node and the at least one mapping between a slice group and a tracking area and/or at least one SGM configuration is obtained from a core network node (which may e.g. be an AMF) for example in response to an initial message sent from the radio access network node to the core network node. In some examples, such an initial message may include or comprise information specific to a user device to which the SGM configuration is to be provided. In this way, the core network node may for example select (e.g. based on a registration area which may be available at the core network and which may be assigned to the user device specified by the information included initial message) at least one mapping between a slice group and a tracking area and/or at least one SGM configuration according to the user device to which the SGM configuration is to be provided. Further considering this example, the one or more selected mappings and/or SGM configurations are then provided by the core network node to the radio access network node providing the SGM configuration.

Considering the example that at least one mapping between a respective slice group and a respective tracking area and/or at least one SGM configuration is obtained from a core network node, this at least one mapping and/or at least one SGM configuration may in turn be obtained at the core network node e.g. from further radio access network nodes (e.g. including the radio access network node that provides the SGM configuration). For example, this may allow that initially no mappings between slice group and tracking and/or no SGM configurations are available at the core network node until such mappings and/or configurations are obtained (e.g. collected) from further radio access network nodes.

In other examples of the second exemplary aspect, the network node may be a radio access network node and the at least one mapping between a slice group and a tracking area and/or at least one SGM configuration may be obtained e.g. from one or more further radio access network nodes. For example, the radio access network node may obtain a plurality of mappings between a respective slice group and a respective tracking area and/or a plurality of SGM configurations from a plurality of further radio access network nodes, wherein a respective mapping of the plurality of mappings and/or a respective SGM configuration is obtained from a respective radio access network node (e.g. in a respective radio access network configuration update). In particular, a respective mapping between a slice group and a tracking area and/or a respective SGM configuration may be obtained from a radio access network node that provides a network cell included in the respective tracking area. This may allow that in some examples of the second exemplary aspect, initially (e.g. only) a mapping between a slice group and a tracking area including or comprising a network cell provided by the radio access network node providing the SGM configuration may be available at the radio access network node providing the SGM configuration. By obtaining mappings between a slice group and a tracking area and/or SGM configurations from further radio access network nodes, the radio access network node providing the SGM configuration may collect a plurality of mappings between respective slice groups and respective tracking areas and/or SGM configurations and provide those in form of an SGM configuration to a user device, which may then perform cell reselection and/or random access operation e.g. to a variety of network cells based on the obtained SGM configuration.

According to an exemplary embodiment of the second exemplary aspect, the first network node is a radio access network node and the obtaining the at least one mapping between a slice group and a tracking area and/or an SGM configuration from a core network node comprises:
obtaining the at least one mapping and/or at least one SGM configuration in an access and mobility management function (AMF) configuration update; and
wherein the obtaining the at least one mapping between a slice group and a tracking area and/or at least one SGM configuration from one or more further radio access network nodes comprises:
obtaining the at least one mapping and/or at least one SGM configuration in one or more RAN configuration updates.

Considering the example that a plurality of mappings between respective slice groups and tracking areas and/or a plurality of SGM configurations is obtained at or by a radio access network node as network node from a core network node, this plurality of mappings and/or SGM configurations may be obtained together in one particular AMF configuration update. In other examples of all exemplary aspects, a plurality of mappings between respective slice groups and tracking areas and/or SGM configurations may be obtained at a radio access network node as network node from a plurality of further radio access network nodes, a respective mapping of this plurality of mappings (and/or a respective SGM configuration of this plurality of SGM configurations) may be obtained from a respective further radio access network node in a respective radio access network configuration update.

According to an exemplary embodiment of the third exemplary aspect, a system may comprise a user device as disclosed according to the first aspect and further a network node as disclosed according to the second aspect, wherein the network node may be a radio access network node or a core network node. As described above with respect to various aspects of the present disclosure, a radio access network node or a core network node according to the second exemplary aspect may communicate with each other and/or may communicate with further radio access network nodes. Accordingly, the system according to the third exemplary aspect may in addition to a radio access network node or a core network as network node and a user device comprise further radio access network nodes.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

In the following, various exemplary embodiments will be described in greater detail with reference to the accompanying drawings, in which

FIG. 1 shows a block diagram of an exemplary embodiment of a user device of the various aspects;

FIG. 2 shows a block diagram of an exemplary embodiment of a network node of the various aspects;

FIG. 3 shows a flow diagram of an example embodiment of the first exemplary aspect;

FIG. 4 shows a flow diagram of an example embodiment of the second exemplary aspect;

FIG. 5 shows an exemplary signaling chart illustrating an example embodiment of the various aspects;

FIG. 6 shows another exemplary signaling chart illustrating an example embodiment of the various aspects;

FIG. 7a and FIG. 7b show another exemplary signaling chart illustrating an example embodiment of the various aspects;

FIG. 8 shows a schematic illustration of examples of tangible and non-transitory computer-readable storage media.

### DETAILED DESCRIPTION

The following description serves to deepen the understanding of the present disclosure and shall be understood to complement and be read together with the description of example embodiments as provided in the above SUMMARY section of this specification.

It should be noted that the network slice may also be called slice in the current disclosure. Slice group includes a set of network slices. The slices included in a slice group may have a common or similar network service characteristic.

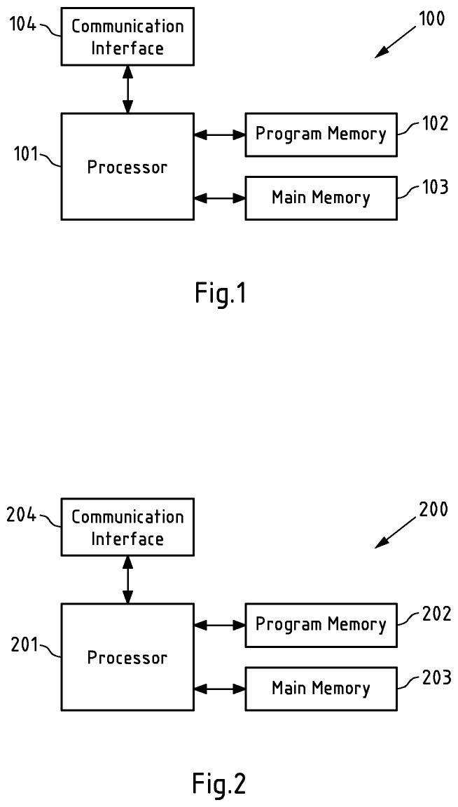

FIG. 1 shown a block diagram of an exemplary embodiment of a user device 100 according to the present disclosure. For example, user device 100 may be one of a smartphone, a tablet computer, a notebook computer, a smart watch, a smart band, an IoT device or a vehicle or a part thereof.

User device 100 comprises a processor 101. Processor 101 may represent a single processor or two or more processors, which are for instance at least partially coupled, for instance via a bus. Processor 101 executes a program code stored in program memory 102 (for instance program code causing user device 100 in connection with network node 200 to perform one or more of the embodiments of a method according to the present disclosure or parts thereof, when executed on processor 101, and interfaces with a main memory 103. Program memory 102 may also contain an operating system for processor 101. Some or all of memories 102 and 103 may also be included into processor 101.

One of or both of a main memory and a program memory of a processor (e.g. program memory 102 and main memory 103) may be fixedly connected to the processor (e.g. processor 101) or at least partially removable from the processor, for instance in the form of a memory card or stick.

A program memory (e.g. program memory 802) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 103) may for instance be a volatile memory. It may for instance be a DRAM memory, to give non-limiting example. It may for instance be used as a working memory for processor 101 when executing an operating system, an application, a program, and/or the like.

Processor 101 further controls a communication interface 104 (e.g. radio interface) configured to receive and/or transmit data and/or information. For instance, communication interface 104 may be configured to transmit and/or receive radio signals from a network node, such as a base station. It is to be understood that any computer program code based processing required for receiving and/or evaluating radio signals may be stored in an own memory of communication interface 104 and executed by an own processor of communication interface 104 and/or it may be stored for example in memory 103 and executed for example by processor 801.

Communication interface 104 may in particular be configured to communicate according to a cellular communication system like a 2G/3G/4G/5G/NR or future generation cellular communication system. User device 100 may use radio interface 104 to communicate with a network node as depicted in FIG. 2.

For example, the communication interface 104 may further comprise a BLE (bluetooth low energy) and/or Bluetooth radio interface including a BLE transmitter, receiver or transceiver. For example, radio interface 104 may additionally or alternatively comprise a WLAN radio interface including at least a WLAN (wireless local area network) transmitter, receiver or transceiver.

The components 102 to 104 of mobile device 100 may for instance be connected with processor 801 by means of one or more serial and/or parallel busses.

It is to be understood that user device 100 may comprise various other components. For example, user device 100 may optionally comprise a user interface (e.g. a touch-sensitive display, a keyboard, a touchpad, a display, etc.).

FIG. 2 is a block diagram of an exemplary embodiment of a network node. For instance, network node 200 may be configured for scheduling and/or transmitting at least one of signals or messages to the user device, as described above.

Network node 200 comprises a processor 201. Processor 201 may represent a single processor or two or more processors, which are for instance at least partially coupled, for instance via a bus. Processor 201 executes a program code stored in program memory 202 (for instance program code causing apparatus 200 to perform alone or together with user device 100 embodiments according to the present disclosure or parts thereof), and interfaces with a main memory 203.

Program memory 202 may also comprise an operating system for processor 201. Some or all of memories 202 and 203 may also be included into processor 201.

Moreover, processor 201 controls a communication interface 204 which is for example configured to communicate according to a cellular communication system like a 2G/3G/4G/5G/NR cellular communication system. Communication interface 204 of network node 200 may be provided for communication between the network node and the user device.

The components 202 to 204 of network node 200 may for instance be connected with processor 201 by means of one or more serial and/or parallel busses.

User device 100 together with communication interface 104 may in particular be configured for receiving signals from a network node 200 and transmitting signals to network node 200 according to the examples describe herein.

It is to be understood that apparatuses 100, 200 may comprise various other components.

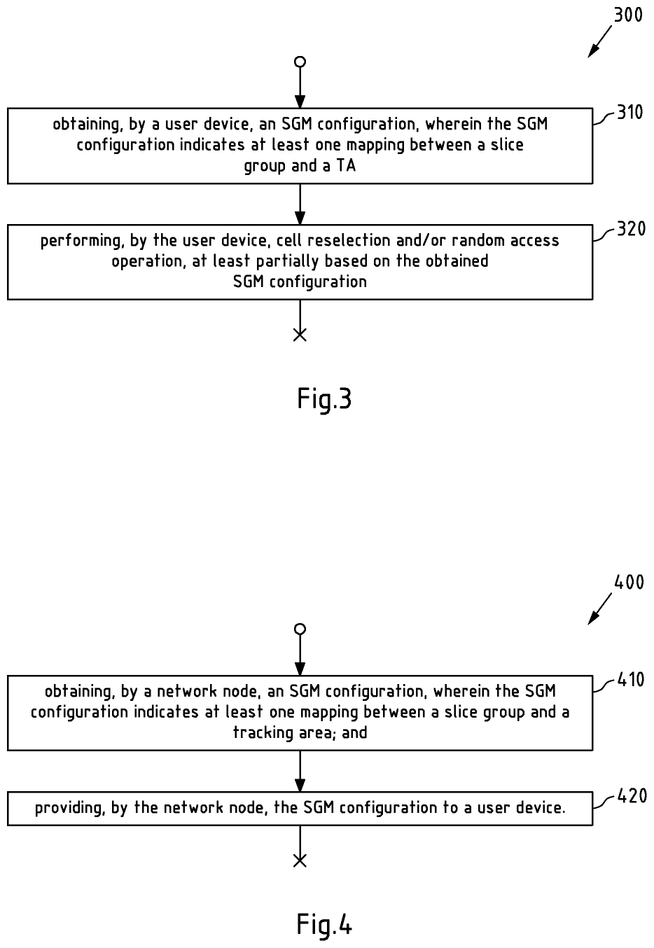

FIG. 3 is a flow diagram 300 illustrating an exemplary embodiment of a method according to the first exemplary aspect of present disclosure. Without limiting the scope of the disclosure, it is assumed in the following that a user device as depicted in FIG. 1 performs the actions/steps of flow diagram 300.

In action 310, the user device obtains an SGM configuration, wherein the SGM configuration indicates at least one mapping between a slice group and a tracking area.

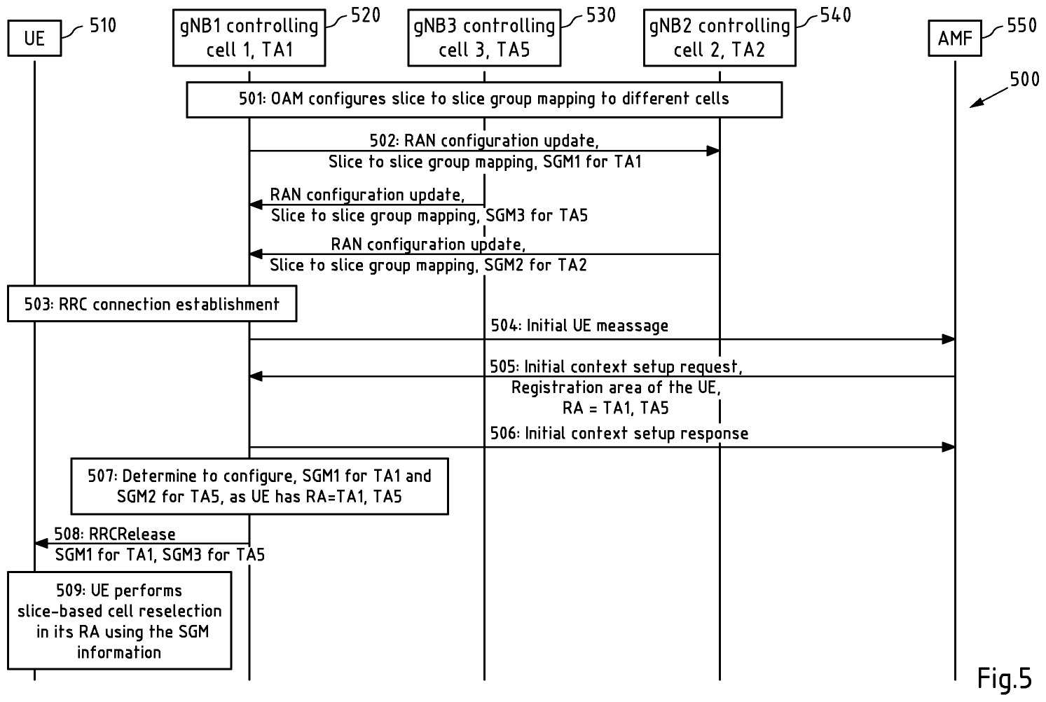

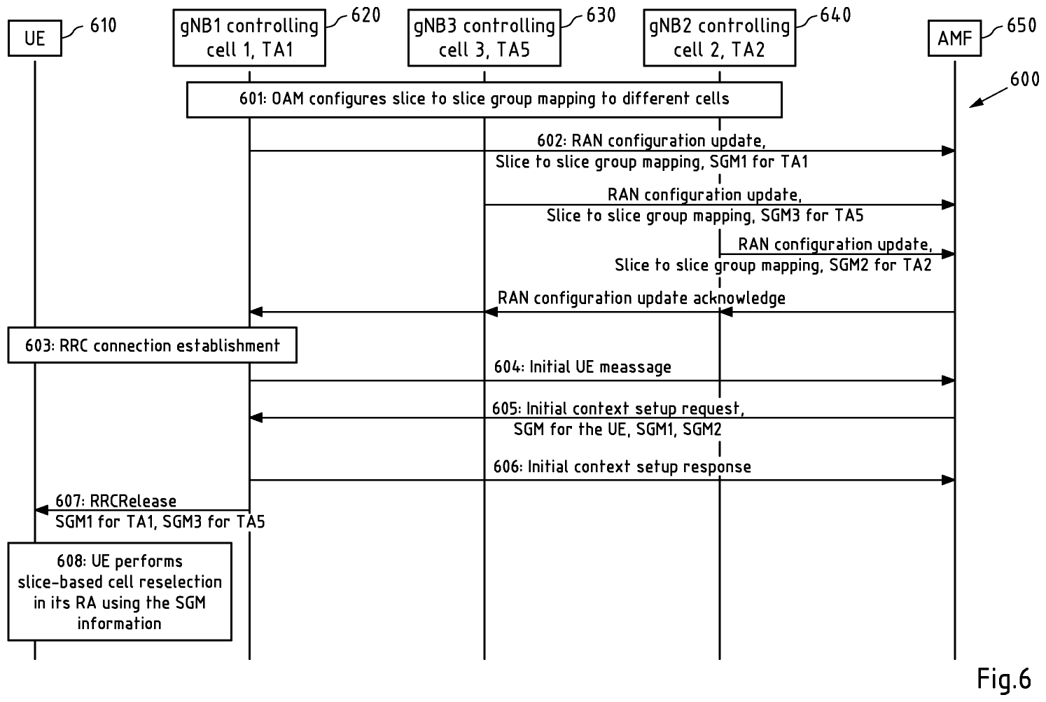

For example, referring to the exemplary embodiment shown in FIG. 5 (action 508 in signaling chart 500), the user device 510 may obtain an SGM configuration by a downlink signaling (e.g. a RRCRelease) from a gNB1 520 as radio access network node, wherein the SGM configuration indicates one or more mappings between SGM and a tracking area (TA). The SGM may further include mappings between a slice (e.g., a first mapping of SGM1 to TA1, and a second mapping of SGM3 to TA5) and a slice group mapping. Similar examples for obtaining an SGM configuration are shown in the exemplary embodiments of FIG. 6 (action 608 in signaling chart 600), 7a and 7b (action 710 in signaling chart 700).

In action 320, the user device performs cell reselection and/or random access operation e.g. to a network cell or a base station, at least partially based on the obtained SGM configuration.

For example, referring to the exemplary embodiment shown in FIG. 5 (action 509 in signaling chart 500), the user device 510 may use the SGM configuration obtained from gNB1 510 as radio access network node when performing slice specific (e.g. slice based) cell reselection. In particular, the obtained SGM configuration indicates (e.g. comprises) mappings between slice groups (e.g. SGM1, SGM3) and tracking areas (TA1, TA5) for tracking areas included in the registration area (RA) assigned to user device 510.

FIG. 4 is a flow diagram 400 illustrating an exemplary embodiment of a method according to the second exemplary aspect of present disclosure. Without limiting the scope of the disclosure, it is assumed in the following that a network node as depicted in FIG. 2 performs the actions of flow diagram 400.

In action 410, the network node obtains at least one mapping between a slice group and a tracking area.

For example, referring to the exemplary embodiment shown in FIG. 5 (action 502 in signaling chart 500), the radio access network node gNB1 520 as network node may obtain one mapping between a slice group (comprising slice to slice group mapping SGM3 for TA5) and a tracking area (TA5) from the gNB3 530 as further radio access network node. Further, the gNB1 520 may obtain one more mappings between a slice group (comprising slice to slice group mapping SGM2 for TA2) and a tracking area (TA2) from the gNB2 540 as another further radio access network node.

In another example, referring to the exemplary embodiment shown in FIG. 6 (action 605 in signaling chart 600), the radio access network node gNB1 520 as network node may obtain two mappings between respective slice groups (respectively comprising slice to slice group mappings SGM1 for TA1 and SGM3 for TA5) and respective tracking areas (TA1 and TA5) from a core network (e.g. an AMF as core network node). A similar example of obtaining mappings from the core network is given in action 703 of signaling chart 700.

In action 420, the network node provides an SGM configuration indicating the least one mapping between a slice group and a tracking area.

For example, referring to the exemplary embodiment shown in FIG. 5 (action 508 in signaling chart 500), the gNB1 520 as radio access network node provides an SGM configuration by a downlink signaling (e.g. a RRCRelease) to user device 510, wherein the SGM configuration indicates two mappings between a slice group comprising a slice to slice group mapping and a tracking area (e.g., a first mapping of SGM1 to TA1, and a second mapping of SGM3 to TA5). Similar examples for providing an SGM configuration are shown in the exemplary embodiments of FIG. 6 (action 608 in signaling chart 600), 7a and 7b (action 710 in signaling chart 700).

The actions/steps according to the exemplary flow diagrams 300 and 400 may provide a solution to the condition that the core network may in general also provide slice to slice group mapping. Further, a particular radio access network node may be unaware of the slice group mapping of other radio access network nodes (e.g. including the neighboring radio access network nodes) if the core network does not provide slice group mapping information/configuration to the particular radio access network node. Further, a radio access network node may be unaware of the registration area assigned to a respective user device.

For example, when a user device is in an idle/inactive state, it may move from one tracking area to another tracking area or within one tracking area. If the slice group mappings in different tracking areas are different, the user device requires information on such differences when reselecting to an appropriate network cell. In another example considering movement within one tracking area, some radio access network nodes (e.g. some gNBs) may lack slice group support, which could imply problems for the user device camping on an appropriate network cell.

For example, the solution provided by example embodiments of all exemplary aspects may allow for a user device to retrieve one or more mappings between slice group and tracking area, wherein such one or more mappings may be valid within a registration area assigned to the user device. In one example, the user device may be configured with such one or more mappings between slice groups and respective tracking areas by a core network. With this SGM configuration, the user device may automatically do cell reselection/random access resource selection based on the SGM configuration.

In another example, one or more mappings are configured by a radio access network node and the one or more mappings are valid within a particular tracking area. For example, a gNB as radio access network node may provide to the user device an SGM configuration indicating a neighboring tracking area's slice group mapping. In such an example, when the user device moves to the neighboring tracking area, it may use this SGM configuration to perform and/or control cell reselection/random access resource selection.

In yet another example, where a gNB cannot obtain a neighboring tracking area's slice group mapping, the user device may perform a slice group mapping update when it moves from tracking area TA1 to tracking area TA2, wherein TA1 and TA2 may belong to the same registration area configured to the user device. For example, when the user device moves from TA1 to TA2, it may indicate an invalid mapping using for example MSG3 or any other uplink message (for an idle/inactive state). In such an example, the network may configure the user device with valid mapping using a downlink message like MSG5 or RRCreconfiguration.

FIG. 5 shows an exemplary signaling chart 500 illustrating an example embodiment of the various aspects of the present disclosure. According to the example embodiment, signaling chart 500 may be understood as a signaling chart for slice group mapping over RAN.

For exemplary purposes and without limiting the scope of the present disclosure, it is assumed in the following that a user device 510 (e.g. a user device 100 as depicted in FIG. 1) communicates with a RAN node denoted gNB1 520 (e.g. a network node 200 as depicted in FIG. 2). Therein, gNB1 controls a network cell 1 (with PCI1), which belongs to TA1. Further according to the example embodiment, gNB1 communicates with further RAN nodes gNB2 540 and gNB3 530, wherein gNB2 540 controls network cell 2 (with PCI2) which belongs to TA2 and gNB3 530 controls network cell 3 (with PCI3) which belongs to TA5. Further according to the example embodiment, all RAN nodes gNB1 520, gNB2 540 and gNB3 540 communicate with an AMF 550 as exemplary core network node.

According to FIG. 5, the information of slice to slice group mapping (denoted in the following with SGM1, SGM2, SGM3) may be included in a respective slice group and corresponding tracking areas (denoted in the following with TA1, TA2, and TA5) and corresponding PCI may be in the form of:
Option 1: [SGM1, SGM2, SGM3] valid under validity area [TA1, TA2, TA5]; or
Option 2: {TA1, SGM1}, {TA2, SGM2}, {TA5, SGM3}; or
Option 3: {PCI1, SGM1}, {PCI2, SGM2}, {PCI3, SGM3}.

Option 3 may be used on TA border edge cases or private networks where the user device is not expected to move across a wide area. Similarly, dynamic slice deployment can be a use case where instead of TA-specific SGM, cell-specific SGM may be needed.

Referring to the example operation shown in FIG. 5, the actions/steps 501 to 510 may be understood as follows:

In action 501, the operations administration and maintenance (OAM) configures slice to slice group mappings to different network cells, which in the given example are the cells 1, 2 and 3 controlled by corresponding gNBs 1, 2 and 3.

In action 502, the gNB1 acquires mappings between TAs and corresponding slice groups which may comprise respective slice to slice group mappings from the neighboring RAN nodes gNB2 and gNB3, whose network cells may have specific TAs according to the example above, which may be {Cell 1, TA1, SGM1}, {Cell 2, TA2, SGM2}, {Cell 3, TA5, SGM3}.

In action 503, the UE may initiate an RRC connection with network cell 1 controlled by gNB1, which in response to initiating the RRC connection transmits an initial UE message to the AMF to acquire the UE context (action 504). According to the present example, the RA (registration area) assigned to the UE may for example be composed of TA1 and TA5, such that RA=[TA1, TA5]. This information is provided at action 505 from the AMF to the RAN node gNB1 and may come from the AMF as a part of an initial context setup request. The transmission according to action 505 may be acknowledged by the UE by an initial context setup response in action 506.

In action 507, RAN node gNB1 which is currently connected to the UE may match the received information and determine the SGM configuration. In particular, UE RA consists of TA1 and TA5, so gNB1 needs the mappings used for these TAs, which are SGM1 and SGM3.

In action 508, RAN node gNB1 sends the determined SGM configuration comprising SGM1 (indicating that it is for TA1) and SGM3 (indicating that it is for TA5) to the UE. When the UE is moving in idle mode and then re-selects a network cell within TA1 or TA5, the UE knows the required SGM and can select the correct RACH resources and/or can make the correct frequency prioritization (action 509).

FIG. 6 shows another exemplary signaling chart 600 illustrating an example embodiments of the various aspects according to the present disclosure. According to the example embodiment, signaling chart 600 may be understood as a signaling chart for slice group mapping provided over RAN, while the TA to SGM mapping is coordinated in the NG interface.

For exemplary purposes and without limiting the scope of the present disclosure, it is assumed in the following that a user device 610 (e.g. a user device 100 as depicted in FIG. 1) communicates with a RAN node denoted gNB1 620 (e.g. a network node 200 as depicted in FIG. 2). Therein, gNB1 may control a network cell 1 (with PCI1), which belongs to TA1.

Further according to the example embodiment, gNB1 may communicate with further RAN nodes gNB2 640 and gNB3 630, wherein gNB2 640 controls network cell 2 (with PCI2) which belongs to TA2 and gNB3 630 controls network cell 3 (with PCI3) which belongs to TA5. Further according to the example embodiment, all RAN nodes gNB1 620, gNB2 640 and gNB3 640 may communicate with an AMF 650 as exemplary core network node.

Referring to the example operation shown in FIG. 6, the actions/steps 601 to 608 may be understood as follows:

In action 601, the OAM may configure slice to slice group mappings to different network cells, which in the given example are the cells 1, 2 and 3 controlled by corresponding gNBs 1, 2 and 3.

In action 602, all RAN nodes may provide either with NG setup message or RAN configuration update the slice group mapping for their corresponding TAs to the AMF. The AMF acknowledges these messages.

In action 603, the UE may initiate an RRC connection with network cell 1 controlled by gNB1, which in response to initiating the RRC connection transmits an initial UE message to the AMF to acquire the UE context (action 604).

In actions 605 and 606, the AMF may answer with the requested UE context and sends the slice group mappings relevant to UE registration area to gNB1. Alternatively, the AMF may include the registration area of the UE in the UE context message as well as the SGMs related to the TAs. In this case, the RAN node gNB1 can do the matching of TAs and related SGM and can send the list of related SGM to the UE.

In action 607, the RAN node gNB1 configures the UE with the determined list of SGMs contained in the determined SGM configuration. The list of SGMs can be configured to the UE over RRCReconfiguration or handover command message. Similarly, the message can be broadcasted in a manner that can only be decoded by a subset of UEs.

In action 608, the UE performs slice-based cell re-selection and/or slice specific RACH operation using the mapping provided by RAN node.

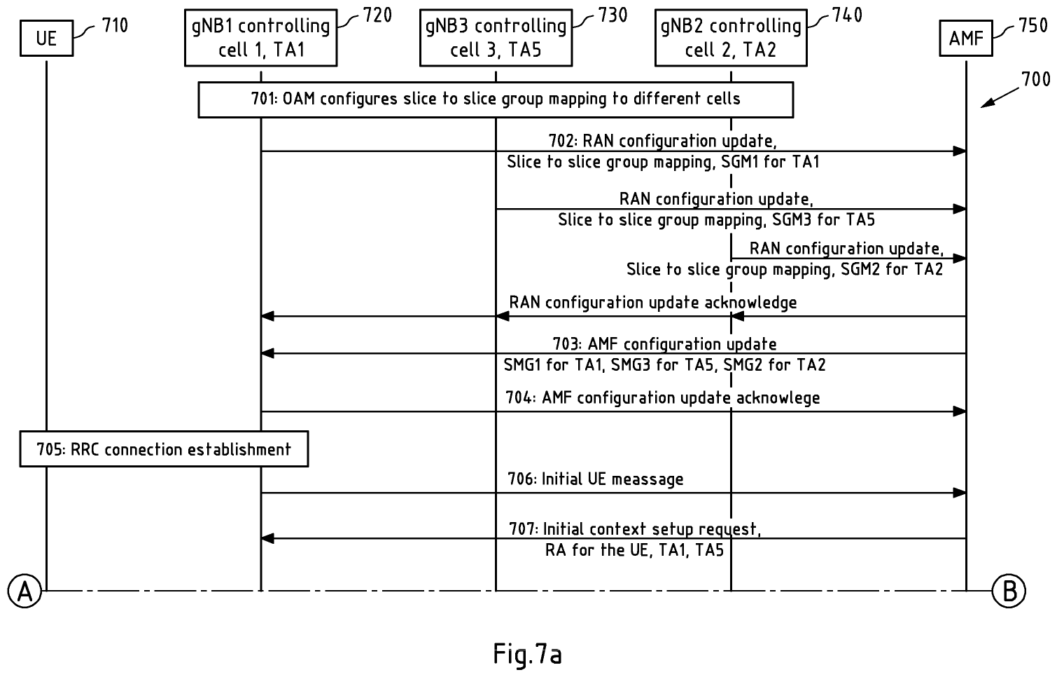

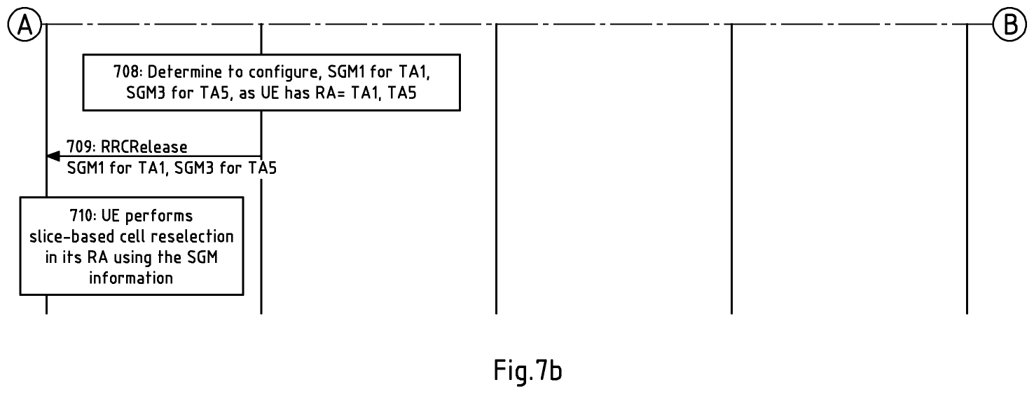

FIG. 7a and FIG. 7b show another exemplary signaling chart 700 illustrating an example embodiment of the various aspects. According to the example embodiment, signaling chart 700 may be understood as a signaling chart for slice group mapping provided over RAN, while the TA to SGM mapping is coordinated in the NG interface.

For exemplary purposes and without limiting the scope of the present disclosure, it is assumed in the following that a UE 710 (e.g. a user device 100 as depicted in FIG. 1) may communicate with a RAN node denoted gNB1 720 (e.g. a network node 200 as depicted in FIG. 2). Therein, gNB1 may control a network cell 1 (with PCI1), which belongs to TA1.

Further according to the example embodiment, gNB1 may communicate with further RAN nodes gNB2 740 and gNB3 730, wherein gNB2 740 controls network cell 2 (with PCI2) which belongs to TA2 and gNB3 730 controls network cell 3 (with PCI3) which belongs to TA5. Further according to the example embodiment, all RAN nodes gNB1 720, gNB2 740 and gNB3 740 communicate with an AMF 750 as exemplary core network node.

Actions 701 and 702 depicted in signaling chart 700 of FIG. 7a and FIG. 7b are identical to actions/steps 601 and 602 depicted in signaling chart 600 of FIG. 6. Accordingly, in action 701, the OAM configures slice to slice group mappings to different network cells, which in the given example are the cells 1, 2 and 3 controlled by corresponding gNBs 1, 2 and 3. Further in action 702, all RAN nodes provide either with NG setup message or RAN configuration update the slice group mapping for their corresponding TAs to the AMF. The AMF acknowledges these messages.

Actions 703 to 708 depicted in signaling chart 700 may be understood as an alternative option to actions/steps 603 to 606 depicted in signaling chart 600 and are explained as follows:

In actions 703 and 704, the AMF provides through an AMF configuration update the list of SGMs mapped to corresponding TAs. In action 705, the UE initiates an RRC connection with network cell 1 controlled by gNB1. Subsequently in actions 706 and 707, the RAN node gNB1 sends the initial UE message to the AMF and the AMF answers with the UE context and sends the registration area of the UE to the RAN Node. In action 708, the RAN node determines which SGMs to configure to the UE related to the registration area assigned to the UE.

Actions 709 and 710 depicted in signaling chart 700 of FIG. 7a and FIG. 7b are identical to actions 607 and 608 depicted in signaling chart 600 of FIG. 6. Accordingly, in action 709, the RAN node gNB1 configures the UE with the determined list of SGMs contained in the determined SGM configuration. The list of SGM can be configured to the respective UE over RRCReconfiguration or handover command message. Similarly, the message can be broadcasted in a manner that can only be decoded by a subset of UEs. In action 710, the UE performs slice-based cell re-selection and/or slice specific RACH operation using the mapping provided by RAN node.

As additional note to the exemplary embodiments given by signaling charts 600 and 700, the list of SGMs where each SGM corresponds to a different TA, can be separate for cell reselection and RACH. The list of SGMs can be extended further for other slice specific feature operation through a different list. Further, if the RA is not available in the RAN, the SGM may be determined merely based on the information exchange over Xn. Thus, the validity area for the provided SGM might be smaller than the RA. Accordingly, the UE may fall back to the legacy cell reselection once the UE is located outside the list of TAs provided by the RAN. In another example of intra-CU cases, the SGM information may be exchanged via F1AP procedures.

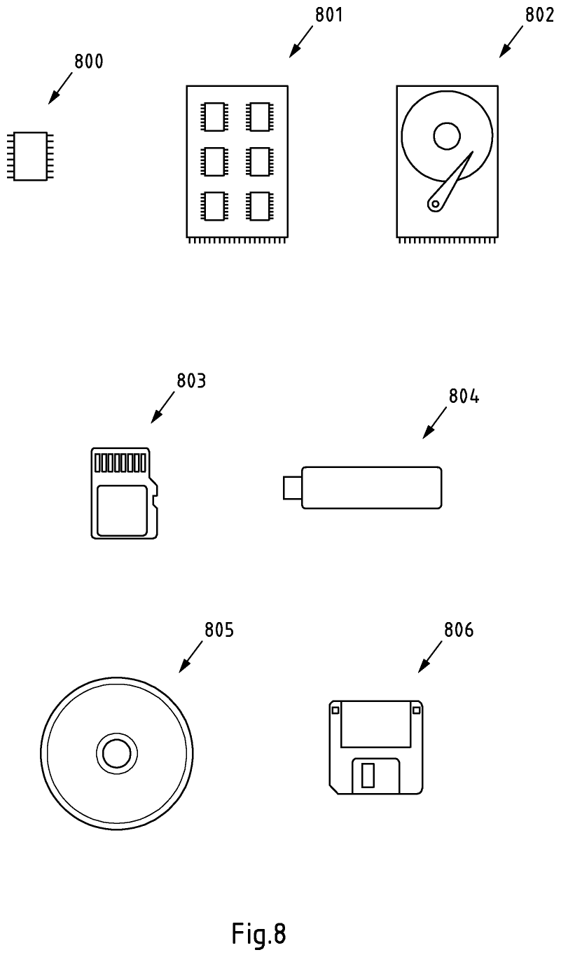

FIG. 8 is a schematic illustration of examples of tangible and non-transitory computer-readable storage media according to the present disclosure that may for instance be used to implement memory 102 of FIG. 1 or memory 202 of FIG. 2. To this end, FIG. 8 displays a flash memory 800, which may for instance be soldered or bonded to a printed circuit board, a solid-state drive 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 101 and 201 of FIG. 1 and FIG. 2, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C. The wording “A and/or B” is considered to comprise any one of the following three scenarios: (i) A, (ii) B, (iii) A and B. Further, the wording “A and/or B” is considered to be equal to the wording “at least one of A and B”.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1-18. (canceled)

19. A user device, comprising:
at least one processor; and
at least one memory including computer program code;
the at least one memory and the computer program code configured to, with the at least one processor, cause the apparatus at least to:
obtain a slice group mapping, SGM, configuration, wherein the SGM configuration indicates a mapping between a slice group and tracking area, TA; and
perform at least one of cell reselection or random access operation, at least partially based on the obtained slice group mapping configuration.

20. The user device of claim 19, wherein the obtain, by the user device, a SGM configuration comprises at least one of:
obtain the SGM configuration from core network; or
obtain the SGM configuration from radio access network.

21. The user device of claim 20,
wherein the obtain the SGM configuration from core network comprises obtain the SGM configuration in non-access stratum (NAS) signaling and/or message; and
wherein the obtain the SGM configuration from radio access network comprises obtain the SGM configuration in a radio resource control (RRC) signaling and/or message.

22. The user device of claim 19, wherein the user device is further caused to:
check whether the SGM configuration is valid for a second TA when the user device moves from a first TA to the second TA; or
check whether the SGM configuration is valid for a second registration area, RA, when the user device moves from a first RA to a second RA.

23. The user device of claim 19, wherein the user device is further caused to:
indicate invalid SGM to a network in an uplink signaling and/or message, wherein the uplink signaling and/or message comprises message 3, MSG3 or MSG5 or MSG1 of a random access channel, RACH or RRC signaling.

24. The user device of claim 19, wherein the slice group mapping configuration comprises at least one of:
a set of slice groups mapping to a set of TAs,
one or more mappings between a slice group and a TA, or
one or more mappings between a physical cell identifier, PCI, and a slice group.

25. The user device of claim 19, wherein the slice group mapping further comprises at least one slice to slice group mapping.

26. A first network node, comprising:
at least one processor and at least one memory including computer program code,
the at least one memory and the computer program code configured to, with the at least one processor, cause the first network node at least to:
obtain a slice group mapping, SGM, configuration, wherein the SGM configuration indicates a mapping between a slice group and tracking area, TA;
provide the SGM configuration to a user device.

27. The first network node of claim 26, wherein the SGM configuration comprises at least one of:
a set of slice groups mapping to a set of TAs,
one or more mappings between a slice group and a TA, or
one or more mappings between a physical cell identifier, PCI, and a slice group.

28. The first network node of claim 26, wherein the slice group mapping further comprises at least one slice to slice group mapping.

29. The first network node of claim 26, wherein the first network node is further caused to:
transmit a slice configuration update to a second network node; or
receive a slice configuration update from a second network node;
wherein the slice configuration update comprises at least one SGM configuration.

30. The first network node of claim 26, wherein the first network node is further caused to determine the SGM configuration.

31. The first network node of claim 26, wherein the first network node is further caused to:
obtain a registration area, RA, configuration of the user device from a core network node to determine the SGM configuration.

32. The first network node of claim 26, wherein the first network node is further caused to perform at least one of:
obtain an assistant information, wherein the assistant information indicates the user device having invalid SGM configuration; or
provide a valid SGM configuration to the user device based on the indicated invalid SGM configuration.

33. The first network node of claim 26, wherein the first network node comprises a core network node and/or a radio access network node.

34. A method, comprising:
obtaining, by a user device, a slice group mapping, SGM, configuration, wherein the SGM configuration indicates a mapping between a slice group and tracking area, TA;
performing at least one of cell reselection or random access operation, at least partially based on the received slice group mapping configuration.

35. The method of claim 34, wherein the obtaining, by the user device, a SGM configuration comprises at least one of:
obtaining the SGM configuration from core network; or
obtaining the SGM configuration from radio access network.

36. The method of claim 34, further comprising:
checking whether the SGM configuration is valid for a second TA when the user device moves from a first TA to the second TA; or
checking whether the SGM configuration is valid for a second registration area, RA, when the user device moves from a first RA to a second RA.

37. The method of claim 34, further comprising:
indicating invalid SGM to a network in an uplink signaling and/or message, wherein the uplink signaling and/or message comprises message 3, MSG3 or MSG5 or MSG1 of a random access channel, RACH or RRC signaling.

38. The method of claim 34, wherein the slice group mapping configuration comprises at least one of:
a set of slice groups mapping to a set of TAs,
one or more mappings between a slice group and a TA, or
one or more mappings between a physical cell identifier, PCI, and a slice group.
